(19) United States
(12) Patent Application Publication
(10) Pub. No.: US 2020/0094774 A1
(43) Pub. Date: Mar. 26, 2020

(54) WEBBING TAKE-UP DEVICE

(71) Applicant: KABUSHIKI KAISHA TOKAI-RIKA-DENKI-SEISAKUSHO, Aichi (JP)

(72) Inventors: Masanori NAGAMINE, Aichi (JP); Shinichi OKUBO, Aichi (JP)

(21) Appl. No.: 16/618,018

(22) PCT Filed: May 23, 2018
(86) PCT No.: PCT/JP2018/019788

§ 371 Date: Nov. 27, 2019

(30) Foreign Application Priority Data
Jun. 2, 2017 (JP) 2017-110305

(51) Int. Cl. B60R 22/36; B60R 22/28; B60R 22/34

(52) U.S. Cl. CPC B60R 22/36; B60R 22/28; B60R 2022/385; B60R 2022/3421; B60R 22/3413

(57) ABSTRACT

In this webbing take-up device, a first bend portion, a second bend portion, and a third bend portion are formed in a wire. In an initial state of the wire, the wire is supported by a second squeezing portion by being abutted against the second squeezing portion on a base end side in the longitudinal direction thereof from the second bend portion, and is supported by a third squeezing portion by being abutted against the third squeezing portion on a base end side in the longitudinal direction thereof from the third bend portion. As a result, the timings when the wire starts to be squeezed by each one of a first squeezing portion, the second squeezing portion, and the third squeezing portion can each be mutually offset.

### TECHNICAL FIELD

The present invention relates to a webbing take-up device that is provided with a force limiter component.

### BACKGROUND ART

In a seatbelt retractor disclosed, for example, in Japanese Unexamined Patent Application Laid-Open (JP-A) No. 2001-219814, a metal band is entrained around a plurality of baffle-type turning elements. When the metal band is rotated together with a belt reel towards a pull-out direction side, the metal band is deformed by being squeezed by the plurality of baffle-type turning elements so that, as a result, a portion of the rotation force in the pull-out direction of the belt reel becomes absorbed.

When the squeezing of the metal band by the baffle-type turning elements is started, a greater quantity of rotation force is temporarily required than the rotation force in the pull-out direction of the belt reel that is subsequently required in order to squeeze and deform the metal band. Moreover, because a plurality of the baffle-type turning elements are provided, a considerable load is temporarily required in each baffle-type turning element when the squeezing of the metal band is started.

Because of this, if the squeezing of the metal band is started simultaneously by all of the baffle-type turning elements, then the rotation force in the pull-out direction of the belt reel that is temporarily required when the squeezing of the metal band is started becomes even greater.

### SUMMARY OF THE INVENTION

### Technical Problem

In consideration of the above-described circumstances, it is an object of the present invention to provide a webbing take-up device that makes it possible to inhibit rotation force in the pullout direction of a spool that is required when deformation of a force limiter component is started from becoming too great.

### Solution to the Problem

A webbing take-up device of a first aspect of the present invention is provided with a spool that is rotated in a pull-out direction as a result of a webbing being pulled out, and a force limiter portion in which a force limiter component that, in conjunction with rotation in the pull-out direction of the spool, absorbs a portion of a rotation force in the pull-out direction of the spool by being deformed after receiving a load from at least one of a plurality of load imparting portions, and in which a timing when a deformation of the force limiter component by at least one of the plurality of load imparting portions is started is offset from a timing when a deformation of the force limiter component by at least one other of the plurality of load imparting portions is started.

According to the webbing take-up device of the first aspect of the present invention, the timing when deformation of a force limiter component is started by at least one of a plurality of load imparting portions in a force limiter portion is offset from the timing when deformation of the force limiter component is started by at least one other of the plurality of load imparting portions. Because of this, it is possible to inhibit the rotation force in the pull-out direction of the spool that is temporarily required at the time when deformation of the force limiter component is started from becoming too great.

A webbing take-up device of a second aspect of the present invention is characterized in that, in the webbing take-up device of the first aspect, the force limiter component is movable in conjunction with the rotation in the pull-out direction of the spool, and, as a result of being moved, is deformed by the plurality of load imparting portions, and at the time when deformation of the force limiter component by a first load imparting portion among the plurality of load imparting portions is started, a second load imparting portion among the plurality of load imparting portions that is adjacent to the first load imparting portion on an opposite side from the movement direction side of the force limiter component supports the force limiter component, and also restricts movement of a portion of the force limiter component that is located on the opposite side from the movement direction side relative to the supporting portion, and also starts deforming the force limiter component once the portion of the force limiter component that is located on the movement direction side relative to the supporting portion has moved by a predetermined amount.

According to the webbing take-up device of the second aspect of the present invention, at the time when deformation of a force limiter component by a first load imparting portion out of a plurality of load imparting portions is started, a second load imparting portion among the plurality of load imparting portions that is adjacent to the first load imparting portion on an opposite side from the movement direction side of the force limiter component supports the force limiter component. As a result, movement of a portion on the opposite side from the movement direction side of the force limiter component from the supporting portion where the second load imparting portion supports the force limiter component is restricted.

Furthermore, after the portion on the movement direction side of the force limiter component from the supporting portion where the second load imparting component supports the force limiter component has moved by a predetermined amount, the deformation of the force limiter component by the second load imparting portion is started. Because the timings when the respective deformations of the force limiter component start are mutually offset in this way, it is possible to inhibit the rotation force in the pull-out direction of the spool that is temporarily required at the time when deformation of the force limiter component is started from becoming too great.

A webbing take-up device of a third aspect of the present invention is characterized in that, in the webbing take-up device of the first aspect or the second aspect, the force limiter component is provided so as to correspond to each of the plurality of load imparting portions, and is provided with bend portions in which a portion on the movement direction side is bent relative to the portion on the opposite side from the movement direction side taking the load imparting component as a center of curvature, and a bend angle of the portion on the movement direction side of the force limiter component relative to the portion on the opposite side from the movement direction side of the force limiter component in each one of the plurality of bend portions is smaller compared to the bend portion corresponding to the load imparting portion which had started deformation of the force limiter component previously.

According to the webbing take-up device of the third aspect of the present invention, a bend angle of a bend portion in the force limiter component is proportionally smaller in a bend portion corresponding to a load imparting portion whose deformation of the force limiter component starts sooner. Because of this, the sequence in which each deformation of the force limiter component by the plurality of load imparting portions starts can be set using the bend angle in the respective angle portions.

A webbing take-up device of a fourth aspect of the present invention is characterized in that, in the webbing take-up device of any one of the first through third aspects, the force limiter component is provided with a timing adjustment portion that, within a predetermined range towards the opposite side from the movement direction side from the supporting portion of the load imparting portion that supports the force limiter component, is lengthened in a tangential direction of the load imparting portion in the supported portion of the force limiter component.

According to the webbing take-up device of the fourth aspect of the present invention, the force limiter component is provided with a timing adjustment portion. The timing adjustment portion is set within a predetermined range towards the opposite side from the movement direction side from the supporting portion where the load imparting portion supports the force limiter component, and the timing adjustment portion is lengthened in a tangential direction of the load imparting portion in the supported portion of the force limiter component. Because of this, when the force limiter component is moved in conjunction with the rotation in the pull-out direction of the spool, and, as a result of this, the timing adjustment portion of the force limiter component is moved, the timing adjustment portion is moved in a tangential direction of the load imparting portion. Because of this, deformation of the timing adjustment portion in the load imparting portion is inhibited. As a consequence, it is possible to delay the start of the deformation of the force limiter component in the load imparting portion.

A webbing take-up device of a fifth aspect of the present invention is characterized in that, in the webbing take-up device of any one of the second through fourth aspects, the movement of the force limiter component in conjunction with the rotation in the pull-out direction of the spool is a rotation, and the number of the plurality of load imparting portions is an odd number, and the plurality of load imparting portions are provided alternatingly on one side and another side in a direction that intersects the direction of movement of the force limiter component in the direction of the movement of the force limiter component, which movement is made in conjunction with the rotation in the pull-out direction of the spool.

According to the webbing take-up device of the fifth aspect of the present invention, the movement of the force limiter component that is made in conjunction with the rotation in the pull-out direction of the spool is a rotation, and the plurality of load imparting portions are provided alternatingly on one side and another side in a direction that intersects the direction of movement of the force limiter component in the direction of the movement of the force limiter component, which movement is made in conjunction with the rotation in the pull-out direction of the spool.

Here, the number of load imparting components is set as an odd number. Because of this, an angle formed between a direction of movement in the portion on the movement direction side of the force limiter component from the load imparting portion located furthest to the movement direction side of the force limiter component among the plurality of load imparting portions, and the direction of movement in the portion on the opposite side from the movement direction side of the force limiter component from the load imparting portion located furthest to the opposite side from the movement direction side of the force limiter component among the plurality of load imparting portions can easily be set to 180 degrees or greater. As a consequence, the placement of a plurality of load imparting portions in a structure in which a force limiter component is rotated in conjunction with the rotation in a pull-out direction of a spool can be easily performed.

### Advantageous Effects of the Invention

As has been described above, in the webbing take-up device according to the present invention, it is possible to inhibit the rotation force in the pull-out direction of the spool that is temporarily required when the deformation of the force limiter component is started from increasing.

### BRIEF DESCRIPTION OF THE DRAWINGS

FIG. 1 is an exploded perspective view showing principal portions of a webbing take-up device according to a first exemplary embodiment.

FIG. 2 is a side view as seen from an outer side in a vehicle width direction showing initial states of a drive device, an SFL lever, a switching pawl, and a wire.

FIG. 3 is an enlarged side view as seen from an outer side in the vehicle width direction showing respective inclination angles (i.e., curve angles) of a first bend portion, a second bend portion, and a third bend portion in the initial state of the wire, and also wire abutting positions in a first squeezing portion, a second squeezing portion, and a third squeezing portion.

FIG. 4 is an enlarged side view corresponding to FIG. 3 showing a starting state when the squeezing of the wire is started by the second squeezing portion.

FIG. 5 is an enlarged side view corresponding to FIG. 4 showing a stat in which a distance between an abutting portion where the wire abuts against the second squeezing portion and an abutting portion where the wire abuts against the third squeezing portion 66 is at the minimum.

FIG. 6 is an enlarged side view corresponding to FIG. 5 showing a starting state when the squeezing of the wire is started by the third squeezing portion.

FIG. 7 is a side view corresponding to FIG. 2 showing a state in which, after the SFL lever has been rotated in a separation direction, the wire has been rotated in the pull-out direction together with a spool.

FIG. 8 is an enlarged side view corresponding to FIG. 3 showing an initial state of a wire in a second exemplary embodiment.

### DESCRIPTION OF THE EMBODIMENTS

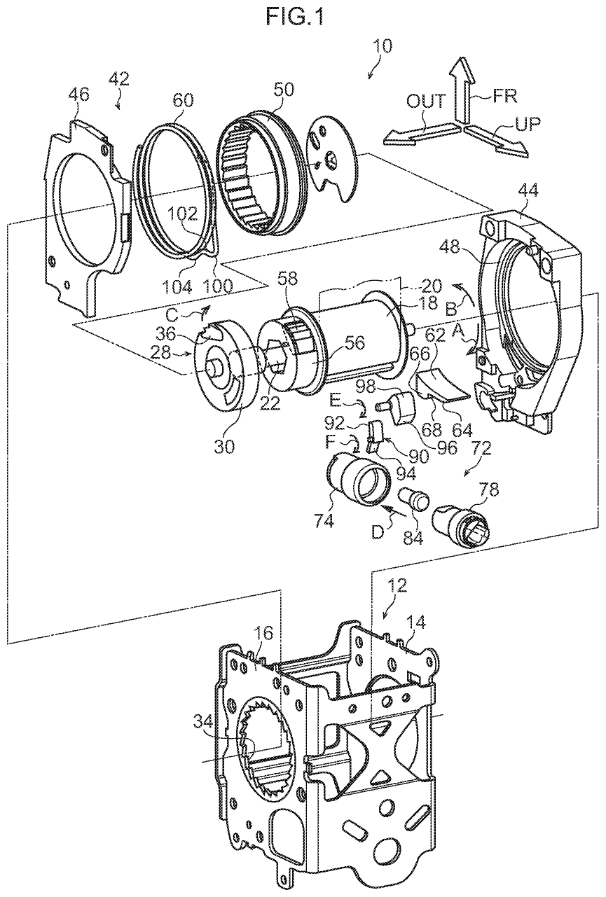

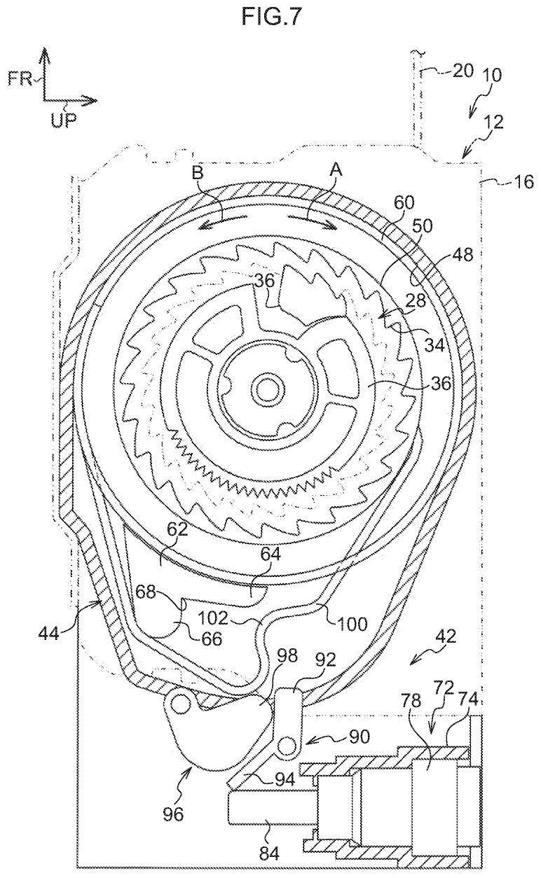

Next, respective exemplary embodiments of the present invention will be described based on FIG. 1 through FIG. 8. Note that in the drawings, an arrow FR, an arrow OUT, and an arrow UP respectively indicate a vehicle front side, an outer side in a vehicle width direction, and a vehicle upper side of a vehicle in which the present webbing take-up device 10 has been applied. In addition, an arrow A in the drawings shows a take-up direction, which is the rotation direction of a spool 18 of the present webbing take-up device 10 when the spool 18 is taking up a webbing 20, while an arrow B shows a pull-out direction, which is the opposite direction from the take-up direction.

Moreover, when each of the following exemplary embodiments are described, portions of the exemplary embodiment currently being described that are fundamentally the same as those described in previous exemplary embodiments including in the first exemplary embodiment are given the same descriptive symbols and any further detailed description thereof is omitted.

### Structure of the First Exemplary Embodiment

As is shown in FIG. 1, the webbing take-up device 10 is provided with a frame 12. The frame 12 is fixed to a vehicle body (not shown in the drawings) on a vehicle rear side of a rear seat (not shown in the drawings) of a vehicle in which the present webbing take-up device 10 has been applied. The frame 12 is provided with a pair of leg plates 14 and 16, and these leg plates 14 and 16 face towards each other in the vehicle width direction. A spool 18 is provided between the leg plate 14 and the leg plate 16 of the frame 12. The spool 18 is formed substantially in a circular cylinder shape. The direction of a central axis of the spool 18 extends in the vehicle width direction, and the spool 18 is able to rotate around this central axis. A base end portion in a longitudinal direction of an elongated-belt shaped webbing 20 is anchored to the spool 18, and the webbing 20 is wound around an outer circumferential portion of the spool 18.

The webbing 20 is pulled out from the spool 18 towards the vehicle front side. The webbing 20 that is pulled out from the spool 18 extends past a vehicle upper side of a seat back of a rear seat and alongside the seat back towards a vehicle lower side on the outer side in the vehicle width direction of a seating position of a vehicle occupant who is sitting in this rear seat, and then passes between the seat back and a seat cushion (neither of these is shown in the drawings) of the rear seat. An anchor plate (not shown in the drawings) is provided on the vehicle lower side of the seat cushion of the rear seat. The anchor plate is fixed to the vehicle body, such as to the floor portion or the like of the vehicle, and a distal end portion in the longitudinal direction of the webbing 20 is anchored to the anchor plate.

A seat belt device for a vehicle in which the present webbing take-up device 10 has been applied is provided with a tongue and with a buckle device (neither of these is shown in the drawings). The tongue is provided on the webbing 20 on the vehicle front side of the seat back of the rear seat, and the tongue is able to move along the webbing 20. In contrast, the buckle device is provided on an inner side in the vehicle width direction of the seating position of the rear seat. After the webbing 20 has been pulled over the body of a vehicle occupant who is sitting in the rear seat, by then engaging the tongue with the buckle device, the webbing 20 can be fitted over the body of the vehicle occupant.

On the other hand, a spool urging portion such as a spiral spring or the like is provided on the inner side in the vehicle width direction of the frame 12. The spool 18 is joined either directly or indirectly to the spool urging portion, and the spool 18 is urged in the take-up direction by the spool urging portion. In addition, a pretensioner (not shown in the drawings) is provided on the inner side in the vehicle width direction of the frame 12. The pretensioner is operated in the event of a vehicle emergency such as in a vehicle collision or the like. As a result of the pretensioner being operated, the spool 18 is rotated in the take-up direction so that, as a result, the webbing 20 is taken up by the spool 18 from the base end side in the longitudinal direction thereof.

Moreover, a torsion bar 22 which serves as rotation force absorption component is provided on an inner side of the spool 18. The torsion bar 22 is formed in the shape of a bar that is elongated in the vehicle width direction, and an end portion on the inner side in the vehicle width direction of the torsion bar 22 is disposed on the inner side of the spool 18. This end portion on the inner side in the vehicle width direction of the torsion bar 22 is joined to the spool 18, and rotation of the torsion bar 22 relative to the spool 18 is blocked.

On the other hand, a lock base 30 which serves as a lock rotation body forming part of a lock mechanism 28 which serves as a locking portion is provided on the outer side in the vehicle width direction of the spool 18. An end portion on the outer side in the vehicle width direction of the torsion bar 22 is joined to the lock base 30, and rotation of the end portion on the outer side in the vehicle width direction of the torsion bar 22 relative to the lock base 30 is blocked. The lock base 30 is disposed on the inner side of a ratchet hole 34 that is formed in the leg plate 16 of the frame 12.

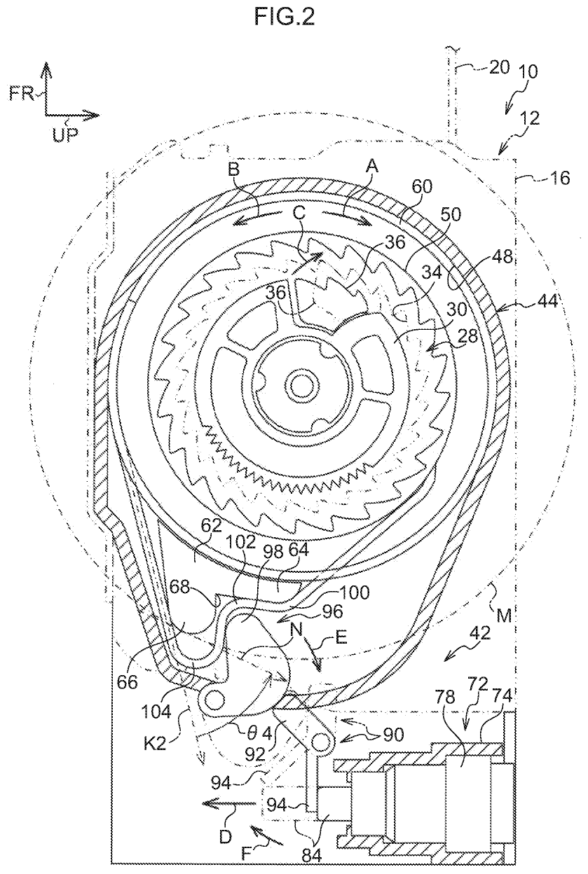

Furthermore, a locking pawl 36 which serves as a locking component is provided in the lock base 30. Ratchet teeth that are able to mesh with ratchet teeth of the ratchet hole 34 of the leg plate 16 of the frame 12 are formed on the locking pawl 36. When the locking pawl 36 is moved in a locking direction (i.e., in a direction shown by an arrow C in FIG. 1 and FIG. 2), the ratchet teeth of the locking pawl 36 are moved towards the ratchet teeth of the ratchet hole 34 and consequently mesh with the ratchet teeth of the ratchet hole 34. As a result, rotation of the lock base 30 in the pull-out direction is blocked.

On the other hand, the lock mechanism 28 is provided with a sensor mechanism (not shown in the drawings). This sensor mechanism is operated when acceleration (deceleration) of the vehicle in the event of a vehicle emergency such as in a vehicle collision or the like is applied thereto, or when rotation acceleration in the pull-out direction of the spool 18 in the event of a vehicle emergency such as in a vehicle collision or the like is applied thereto. As a result of the sensor mechanism being operated, the locking pawl 36 is moved towards the ratchet teeth of ratchet hole 34 in the leg plate 16 of the frame 12.

In addition, as is shown in FIG. 1 and FIG. 2, the present webbing take-up device 10 is provided with a selectable force limiter mechanism 42 which serves as a force limiter portion. Note that, hereinafter, the term ‘selectable force limiter’ is abbreviated to ‘SFL’. This SFL mechanism 42 is provided with an SFL housing 44 which serves as a base component. An SFL sheet 46 which serves as a cover component is provided on the outer side in the vehicle width direction of the SFL housing 44. The SFL housing 44 and the SFL sheet 46 are both formed in a plate shape, and a thickness direction of the SFL housing 44 as well as a thickness direction of the SFL sheet 46 both extend in the vehicle width direction. The SFL housing 44 and the SFL sheet 46 are provided on the leg plate 16 side between the leg plate 14 and the leg plate 16 of the frame 12, and the SFL housing 44 and the SFL sheet 46 are fixed to the leg plate 16 of the frame 12 by means of fastening portions such as screws or the like.

A base ring housing portion 48 is formed in the SFL housing 44. The base ring housing portion 48 is formed as a hole portion that opens in an outer side surface in the vehicle width direction of the SFL housing 44. A base ring 50 which serves as an SFL rotating body is provided on an inner side of the base ring housing portion 48. A cross-sectional shape of an outer-side surface of the base ring 50 is formed in a circular ring shape, and the base ring 50 is provided so as to be coaxial with the spool 18. An end portion on the inner side in the vehicle width direction of the base ring 50 is supported on the SFL housing 44 so as to be able to rotate freely, while an end portion on the outer side in the vehicle width direction of the base ring 50 is supported on the SFL sheet 46 so as to be able to rotate freely.

A pawl housing portion 56 that is formed in an end portion on the outer side in the vehicle width direction of the spool 18 is disposed on the inner side of the base ring 50. An SFL pawl 58 which serves as an SFL linking component is provided in the pawl housing portion 56. The SFL pawl 58 is linked to the lock base 30 of the lock mechanism 28, and this link with the lock base 30 is released as a result of the spool 18 being rotated in the pull-out direction relatively to the lock base 30. When the link between the SFL pawl 58 and the lock base 30 is released in this way, the SFL pawl 58 is moved towards the base link 50 by urging force and the like, and the ratchet teeth of the SFL pawl 58 mesh with the ratchet teeth on the inner-side surface of the base ring 50.

Moreover, a wire 60 that forms a force limiter component of the force limiter portion is provided as an energy absorbing elongated component in the base ring 50. The wire 60 is formed in a spiral shape from an elongated metal wire material. A distal end side in the longitudinal direction of the wire 60 faces towards the pull-out direction side relative to a base end side in the longitudinal direction of the wire 60 and, additionally, the distal end side in the longitudinal direction of the wire 60 is displaced towards the inner side in the vehicle width direction relative to the base end side in the longitudinal direction of the wire 60. This spiral-shaped wire 60 is provided on an outer side in a radial direction of the base ring 50.

Moreover, the wire 60 is held by elastic force in pressure contact with the inner-side surface of the base ring housing portion 48 of the SFL housing 44. As a result, in an initial state, the wire 60 is held in the SFL housing 44. Furthermore, the distal end portion in the longitudinal direction of the wire 60 is anchored to a wire anchoring portion (not shown in the drawings) that is formed in the base ring 50. As a result, the wire 60 is rotated together with the base ring 50. In addition, a piece 62 is provided on the vehicle rear side of the base ring 50 inside the base ring housing portion 48 of the SFL housing 44. A first coil portion on the distal end side in the longitudinal direction of the wire 60 extends past the vehicle rear side of the piece 62, and the base end side in the longitudinal direction from the first coil portion on the distal end side in the longitudinal direction of the wire 60 extends past the vehicle front side of the piece 62.

Moreover, the piece 62 is provided with a first squeezing portion 64 which serves as a load imparting portion of the force limiter portion. This first squeezing portion 64 forms part of a vehicle upper-side portion of the piece 62. When looked at from the outer side in the vehicle width direction, the first squeezing portion 64 is elongated roughly in the vehicle up-down direction, and a vehicle upper-side end of the first squeezing portion 64 is curved so as to bulge towards the vehicle rear side. The piece 62 is further provided with a third squeezing portion 66 which serves as a load imparting portion of the force limiter portion. This third squeezing portion 66 forms part of a vehicle rear-side portion of the piece 62, and is provided on the vehicle lower side of the first squeezing portion 64. A vehicle rear-side end of the third squeezing portion 66 is curved so as to bulge towards the vehicle rear side. A valley portion 68 is formed between the first squeezing portion 64 and the third squeezing portion 66. This valley portion 68 is recessed towards the vehicle front-lower side, and a bottom of the valley portion 68 is disposed on the vehicle lower side from the vehicle upper-side end of the first squeezing portion 64, and on the vehicle front side from the vehicle rear-side end from the third squeezing portion 66.

On the other hand, as is shown in FIG. 1 and FIG. 2, a drive device 72 which forms part of a blocking release portion is provided in the SFL housing 44. The drive device 72 is provided with a base cartridge 74. This base cartridge 74 is held by being linked to the SFL housing 44 or the SFL sheet 46. The base cartridge 74 is formed in a cylindrical shape, and this cylinder extends in the vehicle up-down direction (i.e., is open in the direction shown by the arrow UP in FIG. 1 and FIG. 2 as well as in the opposite direction thereto). A micro gas generator 78 which serves as a drive portion, and a piston 84 which serves as a moving component are provided in the base cartridge 74. Hereinafter, the term ‘micro gas generator’ is abbreviated to ‘MGG’.

The MGG 78 is inserted into the base cartridge 74 from the vehicle upper-side end of the base cartridge 74. A connector (not shown in the drawings) is connected to a vehicle upper-side portion of the MGG 78. The MGG 78 is connected via this connector to an ECU (not shown in the drawings) which serves as a control unit. This ECU is electrically connected to a physique detection unit such as, for example, a load sensor that is provided in the seat cushion or the like of the rear seat, or a webbing pull-out length detection sensor that detects the length of the webbing 20 that is pulled out from the spool 18 of the present webbing take-up device 110.

Based on physique detection signals output from the physique detection unit, a determination is made in the ECU as to whether or not the physique of the vehicle occupant who is sitting in the seating position on the rear seat is normal or larger than normal. If it is determined in the ECU that the physique of the vehicle occupant is smaller than normal, then the activation signal output from the ECU in the event of a vehicle emergency such as a vehicle collision or the like is switched from a High level to a Low level, and the MGG 78 is then operated. As a result, gas is generated in the MGG 78, and pressure from this gas causes the piston 84 to move towards the vehicle lower side (i.e., in a direction shown by an arrow D in FIG. 2).

A switching pawl 90 is provided on a vehicle lower side of the piston 84. This switching pawl 90 is supported on at least one of the SFL housing 44 or the SFL sheet 46, and the switching pawl 90 is able to pivot around an axis whose axial direction extends in the vehicle width direction. The switching pawl 90 is provided with a load receiving piece 94. This load receiving piece 94 faces towards a distal end (i.e., a vehicle lower-side end) of the piston 84 on the vehicle lower side of the piston 84. When, as a result of the MGG 78 being operated, the piston 84 is moved towards the vehicle lower side, the load receiving piece 94 is pressed by the piston 84. As a consequence, the switching pawl 90 is pivoted in a hold release direction (i.e., a direction shown by an arrow F in FIG. 1 and FIG. 2) which is one of the directions around the axis whose axial direction extends in the vehicle width direction.

An SFL lever 96 is provided on the vehicle front side of the switching pawl 90. This SFL lever 96 is supported on at least one of the SFL housing 44 and the SFL sheet 46, and the SFL lever 96 is able to pivot around an axis whose axial direction extends in the vehicle width direction. In the initial state of the SFL lever 96 and the switching pawl 90 (i.e., in the state shown by the solid line in FIG. 2), a holding piece 92 of the switching pawl 90 abuts from the vehicle upper-rear side against the SFL lever 96. As a consequence, pivoting of the SFL lever 96 in a separation direction (i.e., a direction shown by an arrow E in FIG. 1 and FIG. 2) which is one of the directions around the axis whose axial direction extends in the vehicle width direction is blocked. When the switching pawl 90 is pivoted in the holding release direction (i.e. in the direction shown by the arrow F in FIG. 1 and FIG. 2) so as to no longer abut against the SFL lever 96 of the holding piece 92, the SFL lever 96 is pivoted in the separation direction.

Furthermore, the SFL lever 96 is also provided with a second squeezing portion 98 which serves as a load imparting portion of the force limiter portion. In the initial state of the SFL lever 96, a distal end portion of this second squeezing portion 98 is disposed between the vehicle rear-side end of the third squeezing portion 66 and the vehicle upper-side end of the first squeezing portion 64 of the piece 62, and the distal end of the second squeezing portion 98 faces towards the valley portion 68 of the piece 62. Moreover, in the initial state of the SFL lever 96, the distal end of the second squeezing portion 98 is curved so as to bulge towards the vehicle front-lower side and, in this state, the first coil portion on the distal end side in the longitudinal direction of the wire 60 extends between the piece 62 and the distal end of the second squeezing portion 98 of the SFL lever 96.

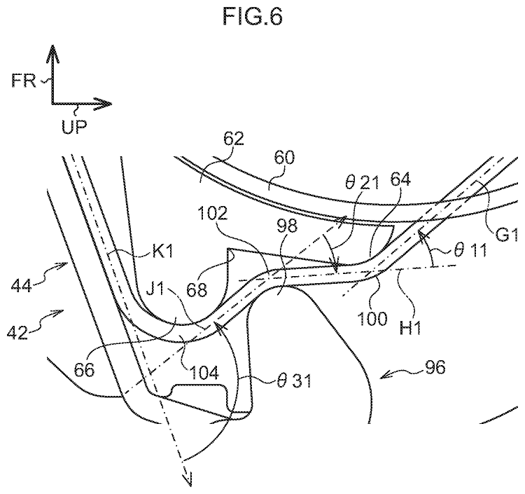

As is shown in FIG. 6, when, in the initial state of the SFL lever 96, the distance between the distal end-side portion in the longitudinal direction of the wire 60 from the first squeezing portion 64 of the piece 62 and the base end-side portion in the longitudinal direction thereof from the third squeezing portion 66 is at the shortest distance, the wire 60 is abutting against the vehicle upper-side end of the first squeezing portion 64, the distal end of the second squeezing portion 98 of the SFL lever 96, and the vehicle rear-side end of the third squeezing portion 66. In this state, the longitudinal direction of the wire 60 in the portion on the distal end side in the longitudinal direction of the wire 60 from the first squeezing portion 64 of the wire 60 (i.e. a direction of an arrow G shown by a single-dot chain line in FIG. 6) is inclined (i.e., is bent) at an angle θ11 relative to the longitudinal direction of the wire 60 in a portion of the wire 60 between the first squeezing portion 64 and the second squeezing portion 98 (i.e. a direction of an arrow H1 shown by the single-dot chain line in FIG. 6). Because of this, when the portion of the wire 60 on the distal end side in the longitudinal direction from the first squeezing portion 64 is moved towards the distal end side in the longitudinal direction of the wire 60, the wire 60 is deformed by being squeezed by the vehicle upper-side end of the first squeezing portion 64.

Moreover, in the state shown in FIG. 6, the longitudinal direction of the wire 60 in the portion of the wire 60 between the first squeezing portion 64 and the second squeezing portion 98 (i.e. the direction of the arrow H1 shown by the single-dot chain line in FIG. 6) is inclined (i.e., is bent) at an angle θ21 relative to the longitudinal direction of the wire 60 in a portion of the wire 60 between the second squeezing portion 98 and the third squeezing portion 66 (i.e. a direction of an arrow J1 shown by the single-dot chain line in FIG. 6). Because of this, when the portion on the distal end side in the longitudinal direction of the wire 60 from the first squeezing portion 64 is moved towards the distal end side in the longitudinal direction of the wire 60, the wire 60 is deformed by being squeezed by the distal end of the second squeezing portion 98.

Furthermore, in the state shown in FIG. 6, the longitudinal direction of the wire 60 in the portion of the wire 60 between the second squeezing portion 98 and the third squeezing portion 66 (i.e. the direction of the arrow J1 shown by the single-dot chain line in FIG. 6) is inclined (i.e., is bent) at an angle θ31 relative to the longitudinal direction of the wire 60 in a portion of the wire 60 on the base end side in the longitudinal direction of the wire 60 from the third squeezing portion 66 (i.e. a direction of an arrow K1 shown by the single-dot chain line in FIG. 6). Because of this, when the portion on the distal end side in the longitudinal direction of the wire 60 from the first squeezing portion 64 is moved towards the distal end side in the longitudinal direction of the wire 60, the wire 60 is deformed by being squeezed by the vehicle rear-side end of the third squeezing portion 66.

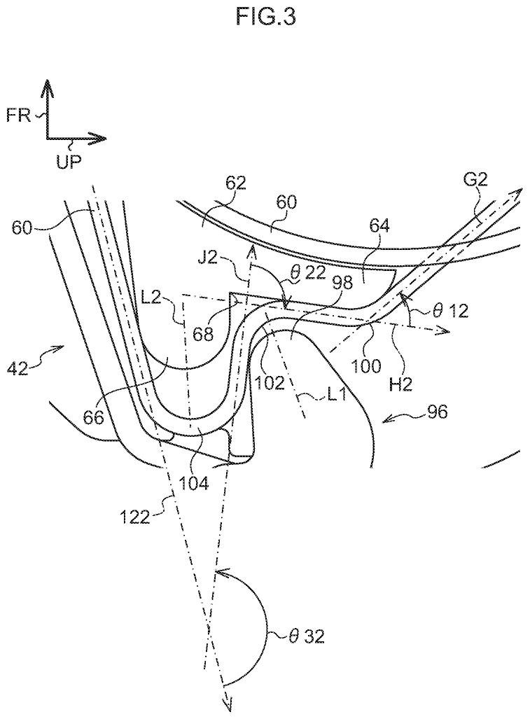

Here, as is shown in FIG. 3, the portion on the distal end side in the longitudinal direction of the wire 60 in the initial state is provided with a first bend portion 100 which serves as a bend portion. This first bend portion 100 is curved so as to extend alongside the vehicle upper-side end of the first squeezing portion 64 of the piece 62, and the first bend portion 100 abuts against the vehicle upper-side end of the first squeezing portion 64. Moreover, in the initial state of the wire 60, the longitudinal direction of the wire 60 in the portion of the first bend portion 100 on the distal end side in the longitudinal direction of the wire 60 (i.e. a direction of an arrow G2 shown by the single-dot chain line in FIG. 3) is inclined (i.e., is bent) at an angle θ12 relative to the longitudinal direction of the wire 60 in a portion of the bend portion 100 on the base end side in the longitudinal direction of the wire 60 (i.e. a direction of an arrow H2 shown by the single-dot chain line in FIG. 6), and this angle θ12 is larger than the aforementioned angle θ11.

Moreover, the wire 60 in the initial state is provided with a second bent portion 102 which serves as a bend portion. The second bend portion 102 is provided on the base end side in the longitudinal direction of the wire 60 from the first bend portion 100. In the second bend portion 102, the wire 60 is curved so as to bulge towards the vehicle front-lower side. Moreover, the second bend portion 102 is disposed between the valley portion 68 of the piece 62 and the distal end of the second squeezing portion 98 of the SFL lever 96. In the initial state of the wire 60, the longitudinal direction of the wire 60 in the portion on the distal end side in the longitudinal direction of the wire 60 of the second bend portion 102 (i.e., the direction of the arrow H2 shown by the single-dot chain line in FIG. 3) is inclined (i.e., is bent) at an angle θ22 relative to the longitudinal direction of the wire 60 in the portion on the base end side in the longitudinal direction of the wire 60 of the second bend portion 102 (i.e., a direction of an arrow J2 shown by the single-dot chain line in FIG. 3), and this angle θ22 is larger than the aforementioned angle θ21, and larger than the aforementioned angle θ12.

Furthermore, the wire 60 is abutted against the second squeezing portion 98 on the base end side in the longitudinal direction from the second bend portion 102. The abutting position where the wire 60 abuts against the second squeezing portion 98 is on the base end side in the longitudinal direction of the wire 60 from a center in the width direction of the SFL lever 96 (shown by a single-dot chain line L1 in FIG. 3) of the second squeezing portion 98. Because of this, when the portion on the distal end side in the longitudinal direction of the wire 60 from the second bend portion 102 is moved towards the distal end side in the longitudinal direction of the wire 60, the second bend portion 102 and the portions of the wire 60 on the base end side in the longitudinal direction from the second bend portion 102 are unable, while maintaining their shape, to move towards the distal end side in the longitudinal direction of the wire 60 from the abutting position where they abut against the second squeezing portion 98.

Moreover, the wire 60 in the initial state is provided with a third bent portion 104 which serves as a bend portion. The third bend portion 104 is provided on the base end side in the longitudinal direction of the wire 60 from the second bend portion 102. In the third bend portion 104, the wire 60 is curved so as to bulge towards the vehicle rear-lower side. Moreover, the third bend portion 104 is disposed on the vehicle rear side from the vehicle rear-side end of the third squeezing portion 66 of the piece 62. In the initial state of the wire 60, the longitudinal direction of the wire 60 in the portion on the distal end side in the longitudinal direction of the wire 60 of the third bend portion 104 (i.e., the direction of the arrow J2 shown by the single-dot chain line in FIG. 3) is inclined (i.e., is bent) at an angle θ32 relative to the longitudinal direction of the wire 60 in the portion on the base end side in the longitudinal direction of the wire 60 of the third bend portion 104 (i.e., a direction of an arrow K2 shown by the single-dot chain line in FIG. 3), and this angle θ32 is larger than the aforementioned angle θ31, and larger than the aforementioned angle θ22.

Furthermore, the wire 60 is abutted against the third squeezing portion 66 on the base end side in the longitudinal direction from the third bend portion 104. The abutting position where the wire 60 abuts against the third squeezing portion 66 is on the base end side in the longitudinal direction of the wire 60 from a center in the width direction (shown by a single-dot chain line L2 in FIG. 3) of the third squeezing portion 66. Because of this, when the portion on the distal end side in the longitudinal direction of the wire 60 from the third bend portion 104 is moved towards the distal end side in the longitudinal direction of the wire 60, the third bend portion 104 and the portions of the wire 60 on the base end side in the longitudinal direction from the third bend portion 104 are unable while maintaining their shape to move towards the distal end side in the longitudinal direction of the wire 60 from the position where they abut against the third squeezing portion 66.

Moreover, as is shown in FIG. 2, on a concentric circle M (shown by a single-dot chain line) relative to the spool 18 which is contacted from the inner side by the third squeezing portion 66 of the piece 62, a tangential direction of the concentric circle M at the abutment portion with the third squeezing portion 66 (i.e., a direction of an arrow N shown by a single-dot chain line in FIG. 2) is inclined (i.e., is bent) at an angle θ4 relative to the longitudinal direction of the wire 60 at the portion of the third squeezing portion 104 on the base end side in the longitudinal direction of the wire 60 (i.e., the direction K2 shown by the single-dot chain line in FIG. 3). Because of this, when the SFL lever 96 has been pivoted in the separation direction (i.e., in the direction shown by the arrow E in FIG. 1 and FIG. 2), if the distal end side in the longitudinal direction from the abutting portion where the wire 60 abuts against the third squeezing portion 66 is rotated towards the pull-out direction side around the center of the concentric circle M, then the wire 60 is deformed by being squeezed by the third squeezing portion 66 (see FIG. 6).

### Action and Effects of the First Exemplary Embodiment

In the present webbing take-up device 10, after the webbing 20 that has been pulled from the spool 18 by a vehicle occupant who is sitting in the rear seat of a vehicle has been pulled over the body of that vehicle occupant, if the tongue provided on the webbing 20 is then engaged with the buckle device, the webbing 20 is fitted over the body of the vehicle occupant.

In the event of a vehicle emergency such as a vehicle collision or the like, the sensor mechanism of the lock mechanism 28 is operated and, as a result, the locking pawl 36 of the lock mechanism 28 is moved towards the ratchet teeth of the ratchet hole 34 in the leg plate 16 of the frame 12. As a result, when the ratchet teeth of the locking pawl 36 mesh with the ratchet teeth of the ratchet hole 34, rotation of the lock base 30 in the pull-out direction is blocked. In this way, because the rotation in the pull-out direction of the spool 18 is prevented due to the rotation of the lock base 30 in the pull-out direction being blocked, in this state, the webbing 20 is unable to be pulled from the spool 18, and the body of the vehicle occupant is restricted from moving towards the vehicle front side by the webbing 20.

Moreover, when, in the event of a vehicle emergency, the pretensioner provided on the inner side in the vehicle width direction of the frame 12 is operated, the spool 18 is rotated in the take-up direction. As a result, the webbing 20 is take up by the spool 18, and the body of the vehicle occupant is more firmly restrained that it had been prior to that point.

Furthermore, when rotation in the pull-out direction of the spool 18 is being blocked by the lock mechanism 28, if the rotation force in the pull-out direction that is imparted to the spool 18 from the webbing 20 is greater than a rotation load required to cause the torsion bar 22 to undergo twisting deformation around the central axis thereof, then the portion on the inner side in the vehicle width direction of the torsion bar 22 is rotated in the pull-out direction relatively to the portion on the outer side in the vehicle width direction thereof, and, as a result, the torsion bar 22 undergoes twisting deformation. A portion of the rotation force in the pull-out direction of the spool 18 is used for the twisting deformation of the torsion bar 22 and is thereby absorbed, and a length of webbing 20 that corresponds to the amount of rotation in the pull-out direction of the spool 18 is pulled from the spool 18. The body of the vehicle occupant is able to make an inertial movement towards the vehicle front side for a distance that corresponds to this length of the webbing 20 that is pulled from the spool 18.

Moreover, if the spool 18 is rotated in the pull-out direction while the rotation of the lock base 30 in the pull-out direction is being blocked, then the SFL pawl 58 is moved in a direction approaching the base ring 50, and the ratchet teeth of the SFL pawl 58 mesh with the ratchet teeth on the inner-side surface of the base ring 50. As a result, the base ring 50 becomes linked to the spool 18.

If, in this state, the webbing 20 is pulled further so that the spool 18 is rotated in the pull-out direction, the base ring 50 is rotated in the pull-out direction together with the spool 18, so that the distal end portion in the longitudinal direction of the wire 60 is pulled by the base ring 50, and the distal end portion in the longitudinal direction of the wire 60 is rotated in the pull-out direction together with the base ring 50. As a result, the wire 60 is deformed by being squeezed by the vehicle upper-side end of the first squeezing portion 64 of the piece 62. As a consequence, a portion of the rotation force in the pull-out direction of the spool 18 is used for the twisting deformation of the torsion bar 22 and for the deformation of the wire 60 by the first squeezing portion 64, and is thereby absorbed.

Moreover, the second bend portion 102 of the wire 60 is provided at a distance from the second squeezing portion 98 of the SFL lever 96, and the wire 60 abuts against the second squeezing portion 98 on the base end side in the longitudinal direction from the second bend portion 102. Here, the abutting position where the wire 60 abuts against the second squeezing portion 98 is formed by the base end side on the longitudinal direction of the wire 60 from the center in the width direction of the SFL lever 96 (as shown by the single-dot chain line L1 in FIG. 3) of the second squeezing portion 98.

Because of this, when the distal end portion in the longitudinal direction of the wire 60 is rotated in the pull-out direction together with the base ring 50, and the portion on the distal end side in the longitudinal direction from the second bend portion 102 of the wire 60 is moved towards the distal end side in the longitudinal direction, the wire 60 is supported by the second squeezing portion 98 at the abutting position where it abuts against the second squeezing portion 98. Because of this, the second bend portion 102 and portions of the wire 60 on the base end side in the longitudinal direction from the second bend portion 102 are unable, while maintaining their shape, to move towards the distal end side in the longitudinal direction of the wire 60 from the abutting position with the second squeezing portion 98.

Because of this, when the distal end portion in the longitudinal direction of the wire 60 is rotated in the pull-out direction together with the base ring 50, and the portion on the distal end side in the longitudinal direction from the second bend portion 102 of the wire 60 is moved towards the distal end side in the longitudinal direction, the wire 60 is deformed between the abutting portion where it abuts against the first squeezing portion 64 and the abutting portion where it abuts against the second squeezing portion 98, so that the second bend portion 102 of the wire 60 is moved closer to the second squeezing portion 98.

Due to this deformation of the wire 60, the angle between the longitudinal direction of the wire 60 in the portion on the distal end side in the longitudinal direction from the abutting portion where the wire 60 abuts against the first squeezing portion 64 (i.e., the direction of the arrow G2 shown by the single-dot chain line in FIG. 3) and the longitudinal direction of the wire 60 in the portion on the base end side in the longitudinal direction from the abutting portion where the wire 60 abuts against the first squeezing portion 64 (i.e. the direction of the arrow H2 shown by the single-dot chain line in FIG. 3) is reduced, and the length between the abutting portion where the wire 60 abuts against the first squeezing portion 64 and the abutting portion where the wire 60 abuts against the second squeezing portion 98 is shortened.

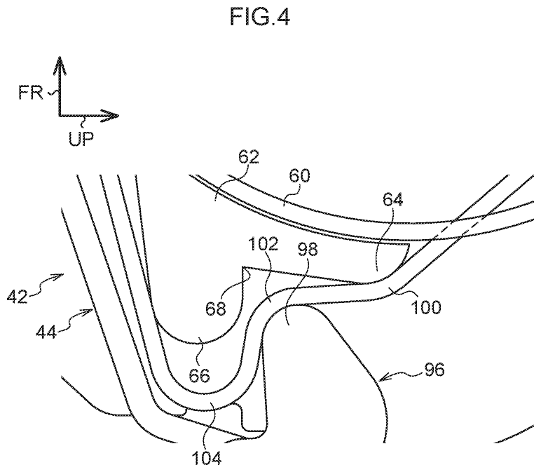

As is shown in FIG. 4, due to this deformation of the wire 60, after the length between the abutting portion where the wire 60 abuts against the first squeezing portion 64 and the abutting portion where the wire 60 abuts against the second squeezing portion 98 has been shortened, if the distal end portion in the longitudinal direction of the wire 60 is then rotated further in the pull-out direction together with the base ring 50, the wire 60 is deformed by being squeezed by the abutting portion where it abuts against the first squeezing portion 64 of the piece 62, and is also deformed by being squeezed by the abutting portion where it abuts against the second squeezing portion 98 of the SFL lever 96. As a consequence, a portion of the rotation force in the pull-out direction of the spool 18 is used for the twisting deformation of the torsion bar 22, and for the deformation of the wire 60 by the first squeezing portion 64 and the second squeezing portion 98, and is thereby absorbed.

Furthermore, the third bend portion 104 of the wire 60 is provided at a distance from the second squeezing portion 66 of the piece 62, and the wire 60 abuts against the third squeezing portion 66 on the base end side in the longitudinal direction from the third bend portion 104. Here, the abutting position where the wire 60 abuts against the third squeezing portion 66 is formed by the base end side on the longitudinal direction of the wire 60 from the center in the width direction of the third squeezing portion 66 (as shown by the single-dot chain line L2 in FIG. 3). Because of this, when the distal end portion in the longitudinal direction of the wire 60 is rotated in the pull-out direction together with the base ring 50, and the portion on the distal end side in the longitudinal direction from the third bend portion 104 of the wire 60 is moved towards the distal end side in the longitudinal direction, the wire 60 is supported by the third squeezing portion 66 at the abutting position where it abuts against the third squeezing portion 66.

Because of this, the third bend portion 104 and portions of the wire 60 on the base end side in the longitudinal direction from the third bend portion 104 are unable, while maintaining their shape, to move towards the distal end side in the longitudinal direction of the wire 60 from the abutting position with the third squeezing portion 66. Moreover, the angle of inclination θ32 between the portion on the distal end side in the longitudinal direction of the wire 60 and the portion on the base end side in the longitudinal direction of the wire 60 of the third bend portion 104 in the initial state of the wire 60 is larger than the angle of inclination θ22 between the portion on the distal end side in the longitudinal direction of the wire 60 and the portion on the base end side in the longitudinal direction of the wire 60 of the second bend portion 102 in the initial state of the wire 60.

Because of this, when, after the squeezing of the wire 60 by the second squeezing portion 98 of the SFL lever 96 has started, the distal end portion in the longitudinal direction of the wire 60 is subsequently rotated further in the pull-out direction together with the base ring 50, and the portion on the distal end side in the longitudinal direction from the third bend portion 104 of the wire 60 is moved towards the distal end side in the longitudinal direction, the wire 60 is deformed between the abutting portion where it abuts against the second squeezing portion 98 and the abutting portion where it abuts against the third squeezing portion 66, so that the third bend portion 104 of the wire 60 is moved closer to the third squeezing portion 66.

Due to this deformation of the wire 60, the angle of the longitudinal direction of the wire 60 in the portion on the distal end side in the longitudinal direction from the abutting portion where the wire 60 abuts against the second squeezing portion 98 (i.e., the direction of the arrow H2 shown by the single-dot chain line in FIG. 3) relative to the longitudinal direction of the wire 60 in the portion on the base end side in the longitudinal direction from the abutting portion where the wire 60 abuts against the second squeezing portion 98 (i.e. the direction of the arrow J2 shown by the single-dot chain line in FIG. 3) is reduced, and the length between the abutting portion where the wire 60 abuts against the second squeezing portion 98 and the abutting portion where the wire 60 abuts against the third squeezing portion 66 is shortened.

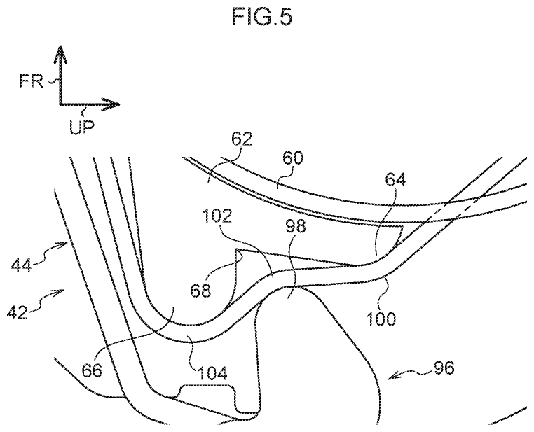

As is shown in FIG. 5, due to this deformation of the wire 60, after the length between the abutting portion where the wire 60 abuts against the second squeezing portion 98 and the abutting portion where the wire 60 abuts against the third squeezing portion 66 has been shortened, if the distal end portion in the longitudinal direction of the wire 60 is then rotated further in the pull-out direction together with the base ring 50, the portion on the base end side in the longitudinal direction from the abutting portion where the wire 60 abuts against the third squeezing portion 66 is pivoted towards the inner wall portion side of the SFL housing 44 (i.e., in a direction indicated by P in FIG. 5) around the abutting portion where the third squeezing portion 66 abuts against the wire 60.

As a consequence, as is shown in FIG. 6, the portion on the base end side in the longitudinal direction from the abutting portion where the wire 60 abuts against the third squeezing portion 66 abuts against the inner wall portion side of the SFL housing 44. If the distal end portion in the longitudinal direction of the wire 60 is rotated from this state further in the pull-out direction together with the base ring 50, then the wire 60 is deformed by being squeezed by the abutting portions where it abuts against each of the first squeezing portion 64 and the second squeezing portion 98, and is also deformed by being squeezed by the abutting portion where it abuts against the third squeezing portion 66. As a consequence, a portion of the rotation force in the pull-out direction of the spool 18 is used for the twisting deformation of the torsion bar 22, and for the deformation of the wire 60 by each of the first squeezing portion 64, the second squeezing portion 98, and the third squeezing portion 66, and is thereby absorbed.

Here, in the present exemplary embodiment, the squeezing of the wire 60 by the second squeezing portion 98 of the SFL lever 96 is started after the squeezing of the wire 60 by the first squeezing portion 64 of the piece 62 has started, and after the distal end portion in the longitudinal direction of the wire 60 has rotated in the pull-out direction together with the base ring 50. In other words, the squeezing of the wire 60 by the second squeezing portion 66 is started after a delay from the start of the squeezing of the wire 60 by the first squeezing portion 64.

Furthermore, the squeezing of the wire 60 by the third squeezing portion 66 of the piece 62 is started after the squeezing of the wire 60 by the second squeezing portion 98 of the SFL lever 96 has started, and additionally, after the distal end portion in the longitudinal direction of the wire 60 has rotated in the pull-out direction together with the base ring 50, and after the portion on the distal end side in the longitudinal direction from the abutting portion where the wire 60 abuts against the third squeezing portion 66 has abutted against the inner wall portion side of the SFL housing 44. In other words, the squeezing of the wire 60 by the third squeezing portion 66 is started after a delay from the start of the squeezing of the wire 60 by the second squeezing portion 98.

In this way, in the present exemplary embodiment, the timings when the squeezing of the wire 60 by each of the first squeezing portion 64, the second squeezing portion 98, and the third squeezing portion 66 are started are mutually offset from each other. Because of this, the timings when the load required to deform the wire 60 (namely, the rotation force in the pull-out direction of the spool 18) temporarily increases due to the squeezing of the wire 60 by each of the first squeezing portion 64, the second squeezing portion 98, and the third squeezing portion 66 starting respectively can also be mutually offset.

As a consequence, when the squeezing of the wire 60 by each of the first squeezing portion 64, the second squeezing portion 98, and the third squeezing portion 66 start respectively, it is possible to inhibit the load required to deform the wire 60, which temporarily increases, from becoming too heavy, and it is accordingly possible to inhibit the load required to deform the wire 60 when the squeezing of the wire 60 by each of the first squeezing portion 64, the second squeezing portion 98, and the third squeezing portion 66 start respectively from becoming too great.

On the other hand, if the physique of a vehicle occupant who is sitting in a seating position in a rear seat which corresponds to the present webbing take-up device 10 is smaller than an average physique, then in the event of a vehicle emergency such as a vehicle collision or the like, the activation signal output from the ECU is switched from a High level to a Low level, and the MGG 78 is then operated. When, as a result, gas is generated in the MGG 78, and the piston 84 is moved towards the vehicle lower side (i.e., in the direction shown by the arrow D in FIG. 2) by pressure from this gas, the load receiving piece 94 of the switching pawl 90 is pressed by the piston 84. As a consequence, the switching pawl 90 is pivoted in a hold release direction (i.e., the direction shown by the arrow F in FIG. 2). As a result of the switching pawl 90 being pivoted in this way, the abutment between the holding piece 92 of the switching pawl 90 and the SFL lever 96 is released.

If, in this state, the distal end portion in the longitudinal direction of the wire 60 is rotated in the pull-out direction together with the base ring 50, the SFL lever 96 is pressed by the abutting portion where the wire 60 abuts against the second squeezing portion 98 of the SFL lever 96 so that, as a result, the SFL lever 96 is pivoted in the separation direction (i.e., in the direction shown by the arrow E in FIG. 2). Because of this, as is shown in FIG. 6, in this state, the distal end side in the longitudinal direction from the abutting portion where the wire 60 abuts against the third bend portion 104 of the piece 62 is pivoted towards the pull-out direction side coaxially with the spool 18, so that the wire 60 is moved away from the first squeezing portion 64 of the piece 62 and the second squeezing portion 98 of the SFL lever 96. Because of this, in this state, the squeezing of the wire 60 by the first squeezing portion 64 and the second squeezing portion 98 does not take place.

In contrast, as is shown in FIG. 2, on a concentric circle M (shown by a single-dot chain line) relative to the spool 18 which is contacted from the inner side by the third squeezing portion 66 of the piece 62, a tangential direction of the concentric circle M at the abutment portion with the third squeezing portion 66 (i.e., the direction of the arrow N shown by a single-dot chain line in FIG. 2) is inclined at an angle θ4 relative to the longitudinal direction of the wire 60 at the portion of the third squeezing portion 104 on the base end side in the longitudinal direction of the wire 60 (i.e., the direction K2 shown by a single-dot chain line in FIG. 3). Because of this, when the distal end portion in the longitudinal direction of the wire 60 is rotated in the pull-out direction together with the base ring 50, the wire 60 is deformed by being squeezed by the third squeezing portion 66 (see FIG. 6).

In this way, if the physique of a vehicle occupant is smaller than an average physique, the squeezing of the wire 60 by the first squeezing portion 64 and by the second squeezing portion 98 do not take place, and the wire 60 is deformed by only being squeezed by the third squeezing portion 66. Because of this, compared with when the physique of a vehicle occupant is larger than an average physique, the amount of rotation force in the pull-out direction of the spool 18 that is absorbed can be reduced.

Furthermore, the present exemplary embodiment is provided with the first squeezing portion 64 and the third squeezing portion 66 of the piece 62, and with the second squeezing portion 98 of the SFL lever 96 (in other words, is provided with three load imparting portions). Because of this, the first bend portion 100, the second bend portion 102, and the third bend portion 104 are provided in the wire 60 (in other words, three bend portions are provided). In this way, in the present exemplary embodiment, there are both a plurality of and an odd number of load imparting portions and bend portions provided respectively. Because of this, an angle formed between the longitudinal direction on the distal end side in the longitudinal direction of the wire 60 from the first bend portion 100 (i.e. the direction of the arrow G2 shown by the single-dot chain line in FIG. 3) and the longitudinal direction on the base end side in the longitudinal direction of the wire 60 from the third bend portion 104 (i.e. the direction of the arrow K2 shown by the single-dot chain line in FIG. 3) can be set to 180 degrees or greater. Because of this, the wire 60 in which the squeezing in the first bend portion 100 has already ended can be folded back towards the vehicle front side, and the wire 60 can be rotated in the pull-out direction together with the spool 18.

### Second Exemplary Embodiment

Next, a second exemplary embodiment will be described.

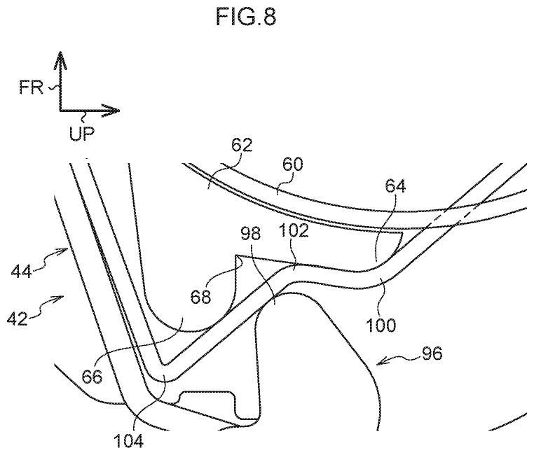

As is shown in FIG. 8, in the present exemplary embodiment, in the initial state the third bend portion 104 of the wire 60 is provided on the base end side in the longitudinal direction of the wire 60 from the abutting portion where the wire 60 abuts against the third squeezing portion 66 of the piece 62. Additionally, the portion between the second bend portion 102 and the third bend portion 104 of the wire 60 in the initial state thereof is provided with a timing adjustment portion 112. The timing adjustment portion 112 is formed in a rectilinear shape, and in addition to abutting against the second squeezing portion 98 of the SFL lever 96, also abuts against the third squeezing portion 66 of the piece 62.

Accordingly, a longitudinal direction of the timing adjustment portion 112 is set as a tangential direction in the abutting portion where the second squeezing portion 98 of the SFL lever 96 abuts against the timing adjustment portion 112, and as a tangential direction in the abutting portion where the third squeezing portion 66 of the piece 62 abuts against the timing adjustment portion 112.

In the present exemplary embodiment which has the above-described structure, the distal end portion in the longitudinal direction of the wire 60 is pulled by the base ring 50 as a result of the base ring 50 being rotated in the pull-out direction together with the spool 18. As a consequence, the wire 60 is deformed until the length between the abutting portion where the wire 60 abuts against the first squeezing portion 64 and the abutting portion where the wire 60 abuts against the second squeezing portion 98 becomes as short as possible. If, from this state, the base ring 50 is rotated further in the pull-out direction together with the spool 18, the wire 60 is moved towards the distal end side in the longitudinal direction thereof, and the wire 60 is consequently deformed by being squeezed by the abutting portion where it abuts against the first squeezing portion 64 of the piece 62, and is additionally deformed by being squeezed by the abutting portion where it abuts against the second squeezing portion 98 of the SFL lever 96.

In this state, the longitudinal direction of the timing adjustment portion 112 of the wire 60 is set as a tangential direction in the abutting portion where the third squeezing portion 66 abuts against the timing adjustment portion 112. Because of this, when the timing adjustment portion 112 is moved towards the distal end side in the longitudinal direction of the wire 60 as a result of the abutting portion where the timing adjustment portion 112 abuts against the third squeezing portion 66 being moved towards the distal end side in the longitudinal direction of the wire 60, although the timing adjustment portion 112 is in sliding contact with the third squeezing portion 66, deformation of the wire 60 by the third squeezing portion 66 is inhibited.

As is shown in FIG. 6, as a result of the wire 60 being moved towards the distal end side in the longitudinal direction thereof in this way, the third bend portion 104 of the wire 60 abuts against the third squeezing portion 66, and if the base ring 50 is then rotated from this state further in the pull-out direction together with the spool 18, the squeezing of the wire 60 by the third squeezing portion 66 is started.

In this way, in the present exemplary embodiment as well, the squeezing of the wire 60 by the third squeezing portion 66 can be started after a delay from the start of the squeezing of the wire 60 by the first squeezing portion 64 and the second squeezing portion 98. Accordingly, the present exemplary embodiment enables fundamentally the same type of effects to be obtained as from the first exemplary embodiment.

Moreover, in the present exemplary embodiment, in the initial state, the portion on the distal end side in the longitudinal direction of the wire 60 from the third bend portion 104 of the wire 60 abuts against the third squeezing portion 66 of the piece 62. Because of this, there is no need to provide a large space on the vehicle lower side of the third squeezing portion 66 (as an example, the side in the direction shown by the single-dot chain line L2 in FIG. 3) in order, for example, to enable the portion on the base end side in the longitudinal direction of the wire 60 from the third bend portion 104 of the wire 60 to abut, in the initial state, against the third squeezing portion of the piece 62.

Note that, in each of the above-described respective embodiments, the number of both the load imparting portions and the bend portions is three, however, the number of load imparting portions and bend portions may instead be two, or may be four or more.

Furthermore, in the present exemplary embodiment, a structure is employed in which the squeezing of the wire 60 is started by the first squeezing portion 64 of the piece 62, and then by the second squeezing portion 98 of the SFL lever 96, and then by the third squeezing portion 66 of the piece 62 in that sequence. However, it is also possible to employ a structure in which, for example, the above-described angle θ22 is made larger than the angle θ32, and the squeezing of the wire 60 by the third squeezing portion 66 is started before the squeezing of the wire 60 by the second squeezing portion 98, and there are no particular restrictions as to the sequence in which the squeezing of the wire 60 by each of the first squeezing portion 64, the second squeezing portion 98, and the third squeezing portion 66 is started.

### INDUSTRIAL APPLICABILITY

Priority is claimed on Japanese Patent Application No. 2017-110305, filed Jun. 2, 2017, the disclosure of which is incorporated herein by reference.

All references, patent applications and technical specifications cited in the present specification are incorporated by reference into the present specification to the same extent as if the individual references, patent applications and technical specifications were specifically and individually recited as being incorporated by reference.

1. A webbing take-up device comprising:
a spool that is rotated in a pull-out direction as a result of a webbing being pulled out; and
a force limiter portion in which a force limiter component that, in conjunction with rotation in the pull-out direction of the spool, absorbs a portion of a rotation force in the pull-out direction of the spool by being deformed after receiving a load from at least one of a plurality of load imparting portions, and in which a timing when a deformation of the force limiter component by at least one of the plurality of load imparting portions is started is offset from a timing when a deformation of the force limiter component by at least one other of the plurality of load imparting portions is started.

2. The webbing take-up device according to claim 1, wherein:
the force limiter component is movable in conjunction with the rotation in the pull-out direction of the spool, and, as a result of being moved, is deformed by the plurality of load imparting portions, and
at a time when deformation of the force limiter component by a first load imparting portion among the plurality of load imparting portions is started, a second load imparting portion among the plurality of load imparting portions that is adjacent to the first load imparting portion on an opposite side from the movement direction side of the force limiter component supports the force limiter component, restricts movement of a portion of the force limiter component that is located on the opposite side from the movement direction side relative to the supporting portion, and starts deforming the force limiter component once the portion of the force limiter component that is located on the movement direction side relative to the supporting portion has moved by a predetermined amount.

3. The webbing take-up device according to claim 1, wherein the force limiter component is provided so as to correspond to each of the plurality of load imparting portions, and is provided with bend portions in which a portion on the movement direction side is bent relative to the portion on the opposite side from the movement direction side taking the load imparting component as a center of curvature, and a bend angle of the portion on the movement direction side of the force limiter component relative to the portion on the opposite side from the movement direction side of the force limiter component in each one of the plurality of bend portions is smaller compared to the bend portion corresponding to the load imparting portion which had started deformation of the force limiter component previously.

4. The webbing take-up device according to claim 1, wherein the force limiter component is provided with a timing adjustment portion that, within a predetermined range towards the opposite side from the movement direction side from the supporting portion of the load imparting portion that supports the force limiter component, is lengthened in a tangential direction of the load imparting portion in the supported portion of the force limiter component.

5. The webbing take-up device according to claim 1, wherein:
the movement of the force limiter component in conjunction with the rotation in the pull-out direction of the spool is a rotation,
the number of the plurality of load imparting portions is an odd number, and
the plurality of load imparting portions are provided alternatingly on one side and another side in a direction that intersects the direction of movement of the force limiter component in the direction of the movement of the force limiter component, which movement is made in conjunction with the rotation in the pull-out direction of the spool.
